(19) United States
(12) Patent Application Publication
(10) Pub. No.: US 2008/0282867 A1
(43) Pub. Date: Nov. 20, 2008

(54) PAD STRUCTURE FOR ELECTRONIC PERCUSSION INSTRUMENT

(76) Inventor: Yu-Chen Liu, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/750,032

(22) Filed: May 17, 2007

(51) Int. Cl. G10D 13/02

(52) U.S. Cl. 84/411 P

(57) ABSTRACT

A pad structure for an electronic percussion instrument is disclosed. The pad structure comprises a first pad portion, a frame and at least one second pad portion. The first pad portion is internally held and surrounded, and the second pad portion is fastened to the first pad portion through fastening elements. The first pad portion and the second pad portion are formed by integrated molding, and the second pad portion has a sensor with a detection wire. The detection wire is connected by the fastening elements to the first pad portion to transmit a signal generated from the second pad portion to the first pad portion

### FIELD OF THE INVENTION

The present invention generally relates to a pad structure for an electronic percussion instrument, and more specifically relates to reduce the manufacture cost and price by decreasing or increasing sub-pad modules upon demands to achieve the personalization.

### BACKGROUND OF THE INVENTION

As technology is developed gradually, the appearance of an electronic percussion instrument such as electronic drum may simulate real drums. A percussion apparatus is provided with a surface which is called by the name of “percussion pads”. The surface is composed of nets that can take impacts applied by percussion forces when a percussionist uses sticks to percuss the surface. The impacts then are detected by the apparatus to generate signals that are processed to output musical sounds. To take stronger impacts, the nets are usually made by specific materials to increase tensions.

Referring to FIG. 1, a schematic diagram illustrates a conventional percussion apparatus. The percussion apparatus 10 includes a frame 11 and a head 12. The head 12 is usually composed of a first net (not shown) and a second net (not shown), each of which is woven in the light of plane weave wherein the longitudinal and transverse fibers cross at right angles, are laminated to one another so as to obliquely their longitudinal and transverse weave pattern directions. The first net and the second net then are bonded to the frame 11. Herein the expression “the weave pattern direction of the first net obliquely crosses that of the second net” means that when the first net wherein the longitudinal and transverse fibers cross at right angles is superposed on the second net wherein the longitudinal and transverse fibers cross at right angles, adjacent fibers in the first net and the second net thus superposed intersect with each other at an angle which is smaller than the right angles.

Even though the weave of the head 11 may take impacts generated by percussions, complexity and manufacture cost are also increased if both nets are utilized.

In addition, the conventional percussion apparatus is usually composed of many percussion pads that also increase complexity and cost. Consequently, consumers may not increase or decrease the number of percussion pads upon demands.

To overcome the foregoing shortcomings, the inventor of the present invention based on years of experience in the related field to conduct extensive researches and experiments, and finally invented a pad structure for an electronic percussion instrument as a method or a basis for achieving the aforementioned object.

### SUMMARY OF THE INVENTION

Therefore, it is a primary object of the present invention to provide a pad structure for an electronic percussion instrument.

To achieve the foregoing object, the pad structure comprises a first pad portion, a frame and at least one second pad portion. The first pad portion is intervally held and surrounded, and the second pad portion is fastened to the first pad portion through fastening elements. The first pad portion and the second pad portion are formed by integrated molding, and the second pad portion has a sensor with a detection wire. The detection wire is connected by the fastening elements to the first pad portion to transmit a signal generated from the second pad portion to the first pad portion.

A second object of the present invention is to provide an electronic percussion instrument that detects percussions and outputs musical sounds based on the percussions. The electronic percussion instrument comprises a pad structure, an interface and an audio output device. The pad structure is percussed from a user end by using sticks to generate signals that then are received by sensors. The interface is used to process the signals that then are converted into audio singles. The audio output device then outputs the audio signals as the musical sounds. The pad portion is composed of the first pad portion and at least one second pad portion. The interface is an audio processing interface that further comprises converters, a processing unit, an input unit and a storage unit. The audio output device is preferably a speaker or an amplifier.

To make it easier for our examiner to understand the object of the invention, its innovative features and performance, a detailed description and technical characteristics of the present invention are described together with the drawings as follows.

### BRIEF DESCRIPTION OF THE DRAWINGS

FIG. 1 is a schematic view of a conventional percussion apparatus;

FIG. 2 is a schematic diagram of a pad structure of the present invention;

FIG. 3 is a schematic diagram of a back side of a pad structure of the present invention;

FIG. 4 is a cross-sectional drawing of a pad structure of the present invention;

FIG. 5 is a schematic diagram illustrating a front, a back and perspective view of a pad structure of the present invention; and

FIG. 6 is a schematic diagram of another example of a pad structure of the present invention;

FIG. 7 is a schematic diagram illustrating a net-like material applied in a pad structure of an electronic percussion instrument according to FIGS. 4 and 6;

FIG. 8 is a schematic diagram illustrating an electronic percussion instrument of the present invention; and

FIG. 9 is a detail block diagram illustrating the electronic percussion instrument of the invention.

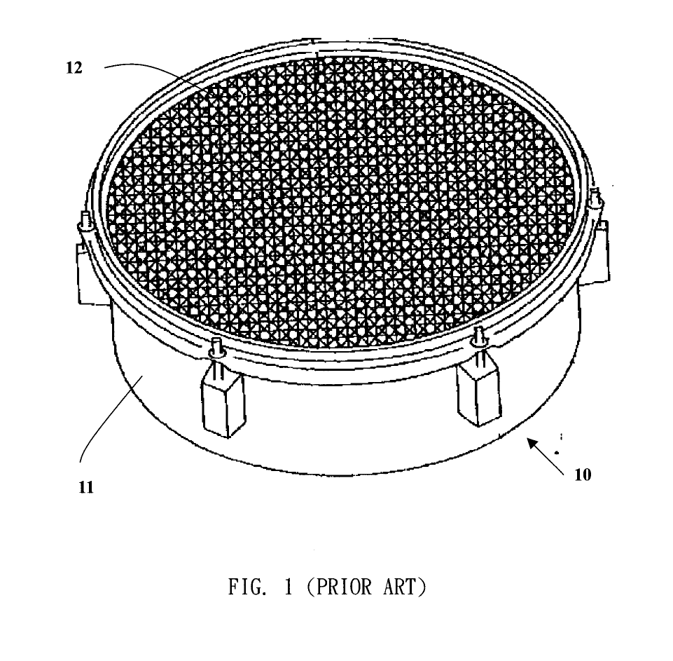

### DETAILED DESCRIPTION OF THE PREFERRED EMBODIMENTS

Referring to the related figures for the pad structure and electronic percussion instrument according to a preferred embodiment of the present invention, wherein the same elements are described by the same reference numerals.

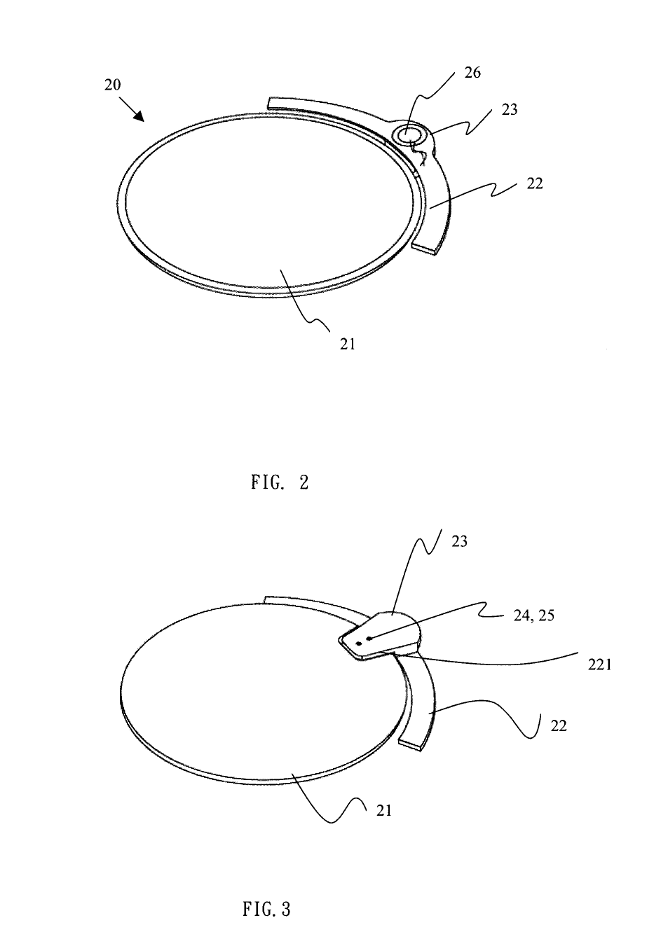

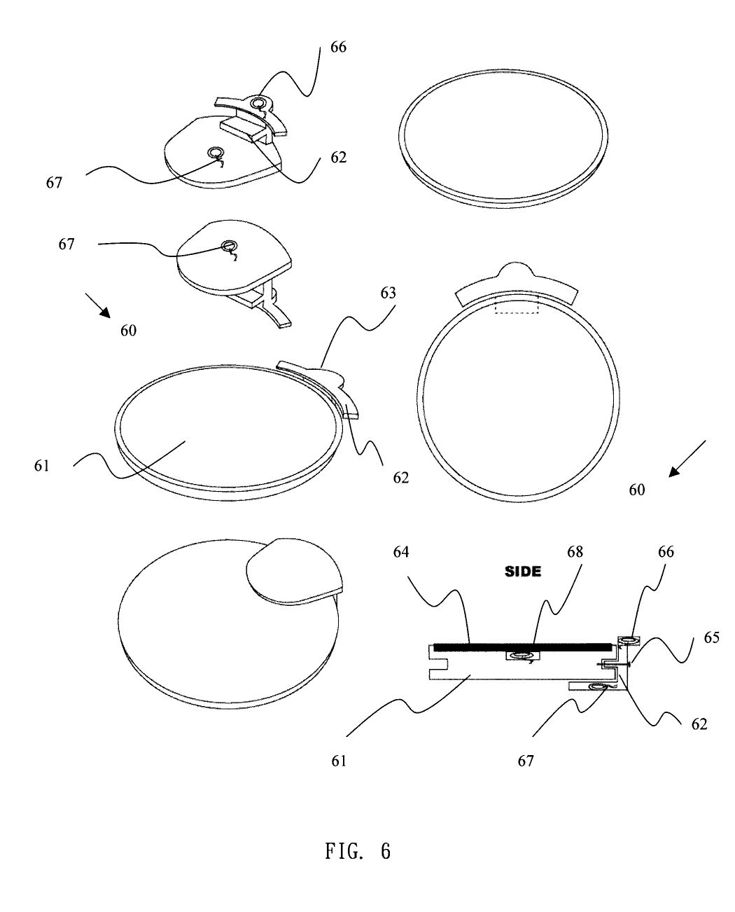

Referring to FIGS. 2, 3, 4 and 5 for the schematic diagrams of a pad structure of the invention, the pad structure 20 is applied for an electronic percussion instrument. The pad structure 20 comprises a first pad portion 21, a frame 22 and at least one second pad portion 23. The first pad portion 21 is intervally held and surrounded by the frame 22. The second pad portion 23 is fastened to the first pad portion 21 through fastening elements such as screws 24 and 25 (back side) and at least one arm 221. The first pad portion 21 and the second pad portion 23 are formed by integrated molding. The second pad portion 23 has a sensor 26 with a detection wire (not shown in the figure). The detection wire is connected by the fastening elements to the first pad portion 21 to transmit a signal generated from the second pad portion 23 to the first pad portion 21.

The pad structure 20 is a drum that can be played by a user with sticks. The first pad portion 21 is a main pad that also has a sensor 29 that could be disposed in the center of the first pad portion 21. The first pad portion 21 further utilizes a rubber, foam or a net-like material 27 to cover a PCV board or a metal to protect the sensor without any damage while percussing the first pad portion 21. The frame 22 is a rim portion to prevent resonance from influencing the first pad portion 21 and the second pad portion 23. The second pad portion 23 is a sub-pad that is an independent sensing device. The screws 24 and 25 are used to lock the second pad portion 23 to the first pad portion 21. The sensor 26 is composed of buzzers or piezoelectric films. The signal is with respect to percussions applied on the second pad portion 23 or the first pad portion 21. In addition, the back of the first pad portion 21 has at least one trough 28 for accommodating the second pad portion 23. Therefore, a user could decrease or increase the second pad portion 23 upon demands. Personalization then is achieved to reduce the manufacture cost and price.

FIG. 6 shows another type of a pad structure for an electronic percussion instrument. The pad structure 60 includes the first pad portion 61, a frame 62 and a second pad portion 63. The first pad portion 61 further has a rubber, foam or a net-like material 64 to be disposed on the first pad portion 61 to protect a sensor disposed in the center of the first pad portion 61 without any damage while percussing the first pad portion 61. The frame 62 is intervally embedded to the first pad portion 61 through screws 65 and 651. The second pad portion 63 has two sensors 66 and 67 respectively adjoined to the top and bottom of the first pad portion 61 to generate signals as the same as a sensor 68 disposed in the center of the first pad portion 61.

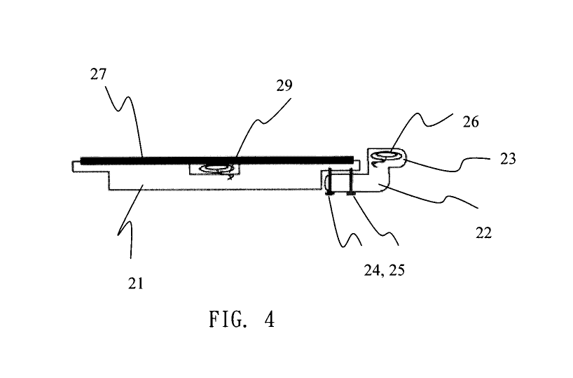

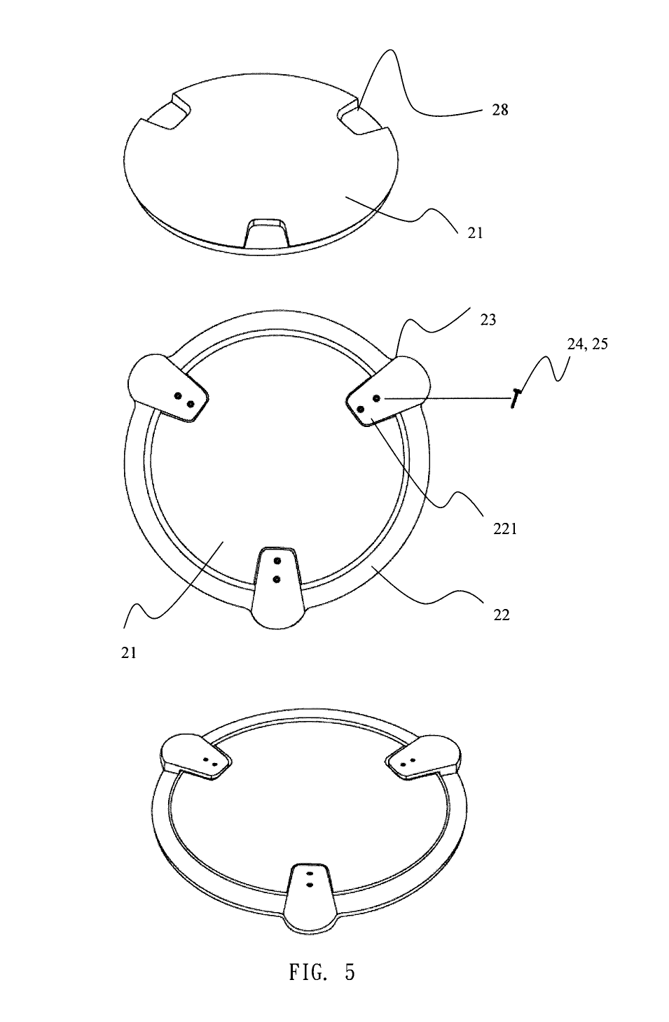

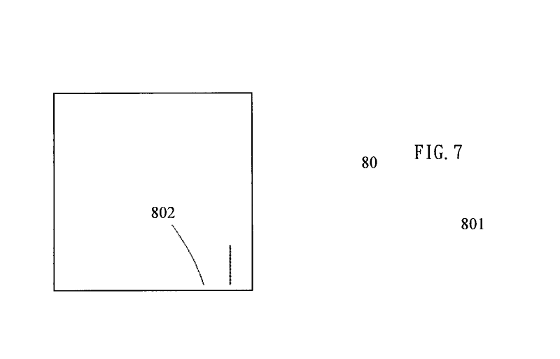

Referring to FIG. 7, a schematic diagram illustrates a net-like material applied in a pad structure of an electronic percussion instrument according to FIGS. 4 and 6. The net-like material 70 is prepared by superposing a plurality of fibers that are formed by combining longitudinal fibers 701 with latitudinal fibers 702 through plane weave. The longitudinal fibers 701 and the latitudinal fibers 702 cross at right angles θ as 90 degrees. The net-like material 70 could take impacts generated by the percussions without using two nets as described in prior art. The net-like material 70 could be directly fastened on the first pad portion to protect the sensor disposed in the center of the first pad portion as shown in FIG. 2.

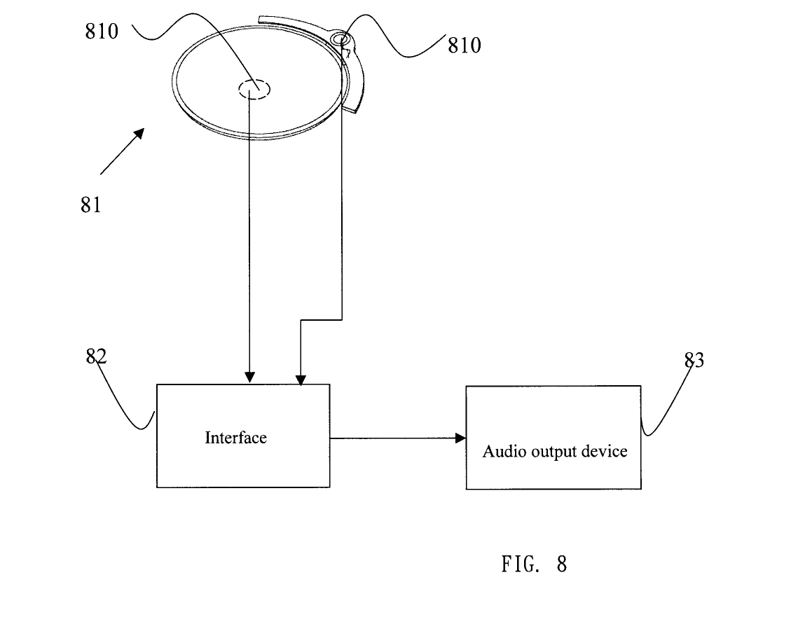

According to the pad structure as described above, an electronic percussion instrument system is further developed. Referring to FIG. 8, a schematic diagram illustrates an electronic percussion instrument of the present invention. The electronic percussion system 80 is applied for detection percussions and outputting musical sounds based on the percussions, and comprises the pad structure 81, an interface 82 and an audio output device 83. The pad structure 81 is percussed from a user end (not shown) by using sticks to generate signals that then are received by the sensors 810. The interface 82 is used to process the signals that then are converted into audio signals. The audio output device 83 receives the audio signals that are therefore outputted as the musical sounds.

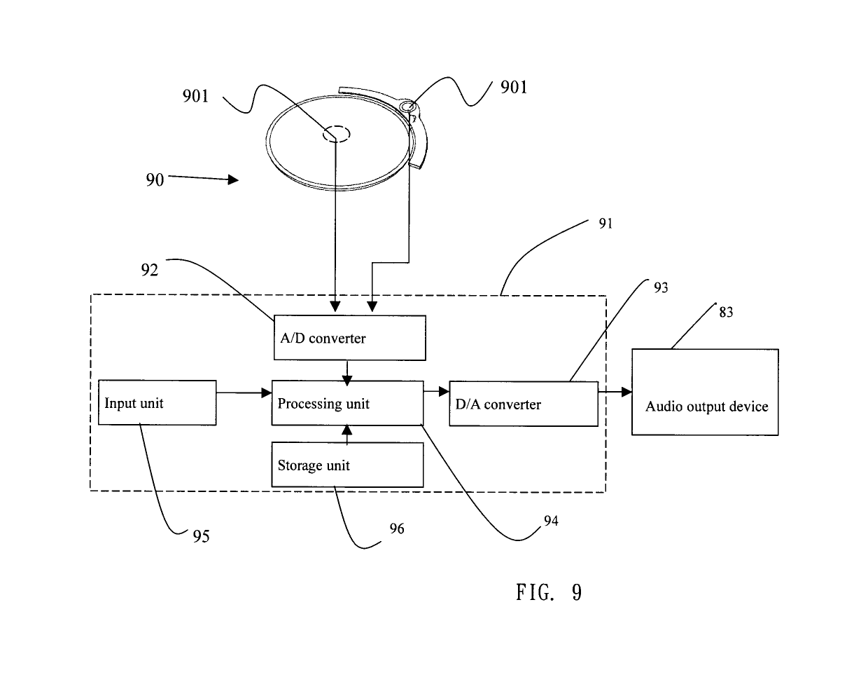

Referring to FIG. 9, a detail block diagram illustrates the electronic percussion instrument of the invention. The sensors 901 are used to detect the percussions applied on the pad structure 90 to generate signals. The interface 91 is an audio processing interface that further comprises converters 92, 93, a processing unit 94, an input unit 95 and a storage unit 96. The converters further include an analog-to-digital (A/D) converter 92 and a digital-to-analog (D/A) converter 93. The analog-to-digital (A/D) converter 92 can perform analog-to-digital conversion of the signals detected by the sensors 901. A processing unit 94 is preferably a processor that processes the digital signals converted by the AD converter 92. Moreover, the input unit 95 can transmit instructions of which are inputted by the user end (not shown), such as tone color, setting level, tuning adjustment, and so forth, to the processing unit 94. The storage unit 96 stores software or a program which can be executed by the processing unit 94. According to the instructions, the processing unit 94 then processes the digital signals by executing software or the program to generate digital musical signals that then are transmitted to the DA converter 93. The DA converter 93 converts the digital musical signals into analog musical signals that then are transmitted to the audio output device 83. The audio output device 83 is preferably a speaker or an amplifier. Furthermore, the processing unit can determine position data being contained in the signals with respect to the percussions percussed on the first pad portion and the second pad portion of the pad structure as illustrated in FIG. 2.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pad structure for an electronic percussion instrument, the pad structure comprising:
a first pad portion;
a frame intervally held and surrounded the first pad portion; and
at least one second pad portion fastened to the first pad portion through fastening elements,
wherein the first pad portion and the second pad portion are formed by integrated molding, and the second pad portion has a sensor with a detection wire, and the detection wire is connected by the fastening elements to the first pad portion to transmit a signal generated from the second pad portion to the first pad portion.

2. The pad structure of claim 1, wherein the pad structure is a drum played by a user end with sticks.

3. The pad structure of claim 1, wherein the first pad portion is a main pad that has a sensor to be disposed in the center of the first pad portion.

4. The pad structure of claim 1, wherein the first pad portion further has at least one fastening trough for accommodating the second pad portion.

5. The pad structure of claim 1, wherein the first pad portion further utilizes a rubber, foam or a net-like material to cover a PCV board or a metal, thereby protecting the sensor disposed in the center of the first pad portion.

6. The pad structure of claim 1, wherein the frame is a rim portion to prevent resonance from influencing the first pad portion and the second pad portion.

7. The pad structure of claim 1, wherein the second pad portion is a sub-pad that is an independent sensing device.

8. The pad structure of claim 1, wherein the fastening elements are screws and arms, and the screws are used to lock the second pad portion to the first pad portion.

9. The pad structure of claim 1, wherein the sensor is composed of buzzers or piezoelectric films.

10. The pad structure of claim 1, wherein the signal is with respect to percussions applied on the second pad portion or the first pad portion.
